(19) United States
(12) Patent Application Publication
(10) Pub. No.: US 2010/0125635 A1
(43) Pub. Date: May 20, 2010

(54) USER AUTHENTICATION USING ALTERNATIVE COMMUNICATION CHANNELS

(76) Inventors: Vadim Axelrod, San Carlos, CA (US); Steve R. Neville, Orleans (CA); Andrew J. Codrington, Ottawa (CA)

Correspondence Address: HICKMAN PALERMO TRUONG & BECKER, LLP, 2055 GATEWAY PLACE, SUITE 550, SAN JOSE, CA, 95110, US

(21) Appl. No.: 12/272,478

(22) Filed: Nov. 17, 2008

(51) Int. Cl. G06F 15/16; G06F 21/00; H04L 9/00

(52) U.S. Cl. 709/206; 726/4; 380/255

(57) ABSTRACT

Techniques are provided for authenticating a user to a server (and vice-versa) through an Instant Messaging (IM) communication channel instead of through the primary communication channel, e.g., using a web browser. User/server authentication through an IM channel may occur as part of the login process and/or before any transactions are completed. Thus, a client device sends, via the primary communication channel (e.g., using HTTP) a request for a service provided by a server. After the server receives the request, the server establishes an IM communication channel with the client device. The IM communication channel is different than the primary communication channel. Both the server and the client device execute an IM client. The server then uses the IM communication channel to authenticate a user of the client device. The server completes the request.

### FIELD OF THE INVENTION

The present invention relates to authenticating users using an instant communication channel, such as an instant messaging (IM) channel or another real-time, session-oriented communication channels.

### BACKGROUND

Users are increasingly mobile and need access to applications through the Internet, regardless of the users' location and, in many cases, regardless of the user's computing device.

Application providers, such as enterprise IT departments, provide remote email access and/or consumer-oriented services, such as electronic banking. Application providers are exposed to great risk of fraud by illegitimate users when such providers allow Internet access to their respective services.

To mitigate that risk, application providers may concurrently employ a number of tools to ensure only legitimate users can gain access to their respective services. One class of such tools is referred to as user authentication. The most common form of user authentication is based on the username and password paradigm.

Username and password based approaches are often not secure enough because it is possible for illegitimate users to steal the legitimate user's password without the knowledge of the legitimate user. Examples of classes of password theft include (a) phishing where a user is tricked into giving their password to a rogue web site and (b) Man-in-the-Middle (MITM) attacks where an illegitimate party inserts itself in the communication path, pretending to be (1) the user while communicating with the application and (2) the application while communicating with the user.

Alternative, stronger mechanisms to authenticate are available, but such mechanisms suffer their own challenges, such as lack of convenience or usability (which may include cost). A tradeoff exists in many possible authentication approaches between security and usability. The following authentication mechanisms may be referred to as “second-factor authentication options” because they may be used in conjunction with other (e.g., traditional) authentication factors, such as the username and password approach.

For example, one second factor authentication option is to use external hardware to supplement authentication is highly secure. Examples of external hardware include time and/or event synchronous hardware tokens (e.g., IdentityGuard Mini Token from Entrust), challenge/response hardware tokens (e.g., from Vasco), SmartCards (e.g., from ActivCard and DataKey), and challenge/response Grid Cards (e.g., IdentityGuard from Entrust).

However, this approach incurs significant incremental costs and logistical problems with distribution and support of the physical devices. Also, significant challenges with this approach typically lies in its (1) inability to support different user requirements within the same infrastructure, (2) intrusiveness for the end-user, and/or (3) relying on external objects (e.g., cell phone, grid card, token) that may not be present and can be misplaced or lost. Furthermore, when the physical device is used to generate or receive an authentication secret for use through a normal authentication channel (e.g., HTTP over the Internet), that secret may be intercepted in real time and used by an MITM attacker to initiate fraudulent transactions without the knowledge of the user.

Another possible second factor authentication option is to employ real-time challenge response protocols, such as asking the user unique, pre-established questions (e.g., “What is your mother's maiden name?”) through the authentication channel. However, this approach is also vulnerable to an MITM attack.

Another possible second factor authentication option is to examine the computing device (e.g., its IP address) from which the user is authenticating. However, the usability of this approach suffers when the user changes devices often.

Another possible second factor authentication option is out-of-band authentication (i.e., via voice calls, email, or SMS to mobile devices). Out-of-band authentication is promising in that even when the primary communication channel (e.g., via a web interface) has been compromised, the secondary channel is likely to be clear. However, thus far, numerous challenges keep existing out-of-band authentication from being a desirable solution. Some of those challenges include: (a) requiring a significant infrastructure to support voice authentication; (b) the user must be in current possession of his/her cell phone; (c) the user's cell phone must be in range of a cellular tower; (d) the application provider must accurately track the user's mobile phone number over time; and (e) user transcription errors between voice/SMS and a web browser for codes can make the solution fail. SMS to mobile devices is specifically known for lack of timely delivery and lack of guaranteed delivery or even reliable notification of delivery.

Based on the foregoing approaches, there is a significant challenge to increase security while maintaining usability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a sequence diagram that depicts an example set of communications for a user to log in to the user's online bank account, according to an embodiment of the invention;

FIGS. 2A-D are sequence diagrams that depict example sets of communications to authenticate a user after the user has logged in the user's personal account, according to an embodiment of the invention; and

FIG. 3 is a block diagram that illustrates a computer system 300 upon which an embodiment of the invention may be implemented

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are provided herein for allowing end-users (or simply “users”) to authenticate themselves to an application provider through IM communication channels (or simply “IM channels”) instead of solely through the primary communication channel. Primary communication channels are typically established using HTTP. Conversely, techniques are provided for allowing the application provider to authenticate itself to users using the IM channel as well, thus providing mutual authentication. The ability to use the IM channel for second factor authentication may be integrated into existing authentication platforms, such as Entrust's IdentityGuard.

With the techniques provided herein, stronger authentication is enabled (a) without hardware-based approaches, (b) without tying the user to a single computing device, and (c) while reducing exposure to MITM and phishing attacks.

Non-limiting examples of client devices that a user might use include a desktop computer, a laptop computer, a cell phone, a personal digital assistant (PDA), and any other client device that is capable of supporting an IM application.

As described hereinafter, most IM services are not truly peer-to-peer (P2P), i.e., most IM services require a central server for messages to pass through. However, embodiments of the invention may include also (a) true P2P technologies, such as Kazaa, and (b) multicast services, such as Twitter.

### Instant Messaging

Both an application provider and a client device are associated with an IM application. A client device may execute its own IM client application. Alternatively, a user of a client device may access his/her IM account through a web browser that executes on the client device. This IM application is referred to as an IM web client. Embodiments of the invention are not limited to either client approach. In either approach, whether locally executed or web-based, an IM client application is referred to hereinafter as an “IM client.”

Non-limiting examples of providers of IM clients include Yahoo! Messenger, Google Talk, Windows Live Messenger, AIM, Skype, iTalk, ICQ, Jabber, IRC, Bonjour, Novell GroupWise Messenger, Lotus Sametime, Gadu-Gadu, QQ, OTR, Facebook IM, MySpace IM, SMS gateways.

In some IM clients, encryption is fully integrated, while in other IM clients, encryption is either available as an extension or is not currently available. An encrypted IM channel increases protection from future sophisticated MITM and phishing attacks.

For purposes of brevity, “party A IM's party B” is shorthand for saying that an IM client of party A sends an IM message to an IM client of party B, i.e., via an established IM channel between the IM clients.

### Example IM Usage

The following is an example of the steps that may occur when using an IM client. Although these steps may be performed in most IM services, embodiments of the invention are not limited to these specific steps.
(1) If a user does not already have a copy of IM client software (which often exists on devices based on default installations) installed on the user's device, then the user downloads a copy of the IM client software to the user's device. In a kiosk scenario, common IM clients may already be installed.
(2) The user's device installs the software and the IM client begins executing.
(3) The IM client uses a proprietary protocol to communicate with an IM server.
(4) The user enters his/her name and password information in order to login to the IM server.
(5) The IM client sends the IM server connection information of the user's device. Such connection information includes the IP address of the user's device and the port number assigned to the IM client.
(6) The IM server creates a temporary file that contains the connection information and a list of contacts (or “buddies”) of the user. The IM server determines whether any of the users in the contact list are logged on.
(7) If the IM server determines that any of the user's contacts are logged on, then the IM server sends, to the IM client, a message that includes the connection information for those contacts. The IM server also sends the user's connection information to the users in the contact list that are logged on.
(8) When the IM client receives the connection information for a user in the contact list, the IM client changes the status of that user to “online.”
(9) When the user selects the name of a user in the contact list who is online, a window opens that the user can enter text (or other types of data) into. The user then clicks a “Send” button to communicate the message with that intended recipient.

Because the IM client has the IP address and port number of the computer to which the IM client sent the IM message, the IM message may be sent directly to the IM client on that computer. In other words, the IM server is not required to be involved at this point. All communication may be directly between the two IM clients. However, many conventional IMs go through a central server and, thus, are not truly P2P.

For users at kiosks or other uncontrolled computers, on demand and trusted use of a downloadable IM client may be enabled. The downloadable IM client is signed by a trusted code signing certificate.

### Differences Between IM Traffic and other Types of Data Traffic

One difference between IM traffic and other types of data traffic (such as HTTP, SMS, and email) is that IM traffic is session-based. Whenever an IM channel is established, a session is created and tracked either by the IM clients or by the central IM server(s) (e.g., in the case of most IM services, such as Yahoo! Messenger). Similarly, IM clients may receive (a) an acknowledgment if an IM message is received and (b) a notification if the IM message is not received. In contrast, other types of data traffic are not session-based and there is no inherent mechanism to provide such acknowledgements or notifications. Instead, HTTP, SMS, and email use the send and wait paradigm, where there is no guarantee that a message was properly received.

Another difference between IM traffic and HTTP traffic in particular is that IM traffic is through a different port than HTTP traffic. HTTP traffic typically uses port 80 or port 443 (if the communication is secure, i.e., HTTPS) whereas IM traffic uses different ports, as well as different protocols through those different ports. However, if a user is using an IM web client, then the port used for IM traffic may or may not be the same as the port used in HTTP traffic. For example, Meebo's IM web client uses port 443 and is, consequently, vulnerable to MITM attacks. As another example, AIM Express's Java-based IM web client uses the TOC (or Talk to OSCAR) protocol, which is not vulnerable to currently known MITM attacks. As another example, IM web clients that support Extensible Messaging and Presence Protocol (XMPP) (such as Google Talk and Jabber) are typically not vulnerable to currently known MITM attacks.

### Authentication Challenges and Responses

The combination of IM with an application's normal communication channel (e.g., using HTTP) opens up numerous options for challenge/response exchanges that can serve to authenticate a user to an application provider, and/or the application provider to the user. The IM channel also provides the ability to convey contextual information about a particular transaction.

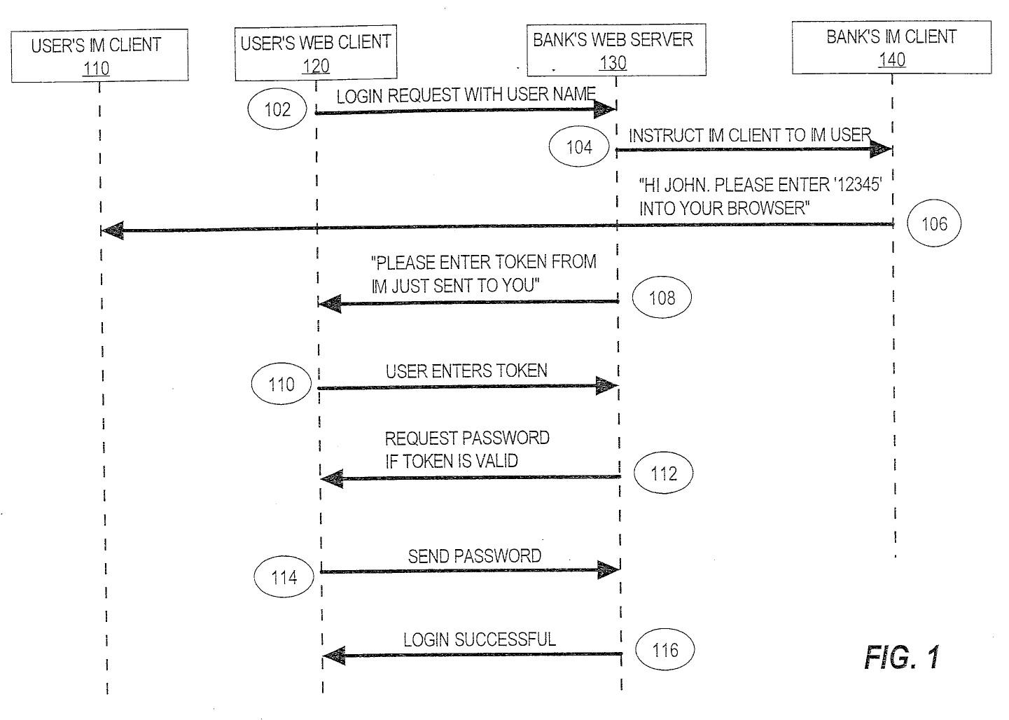

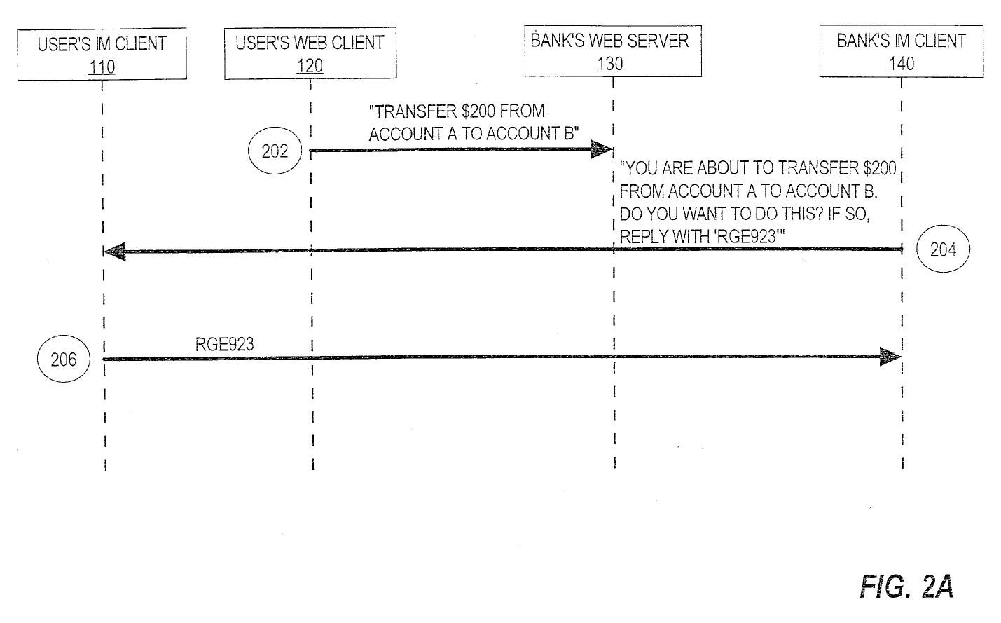

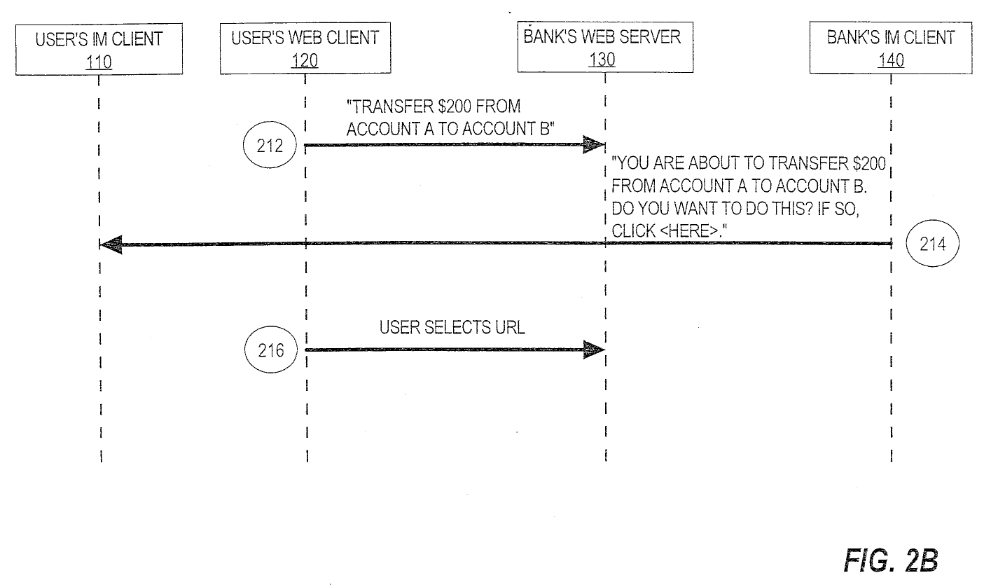

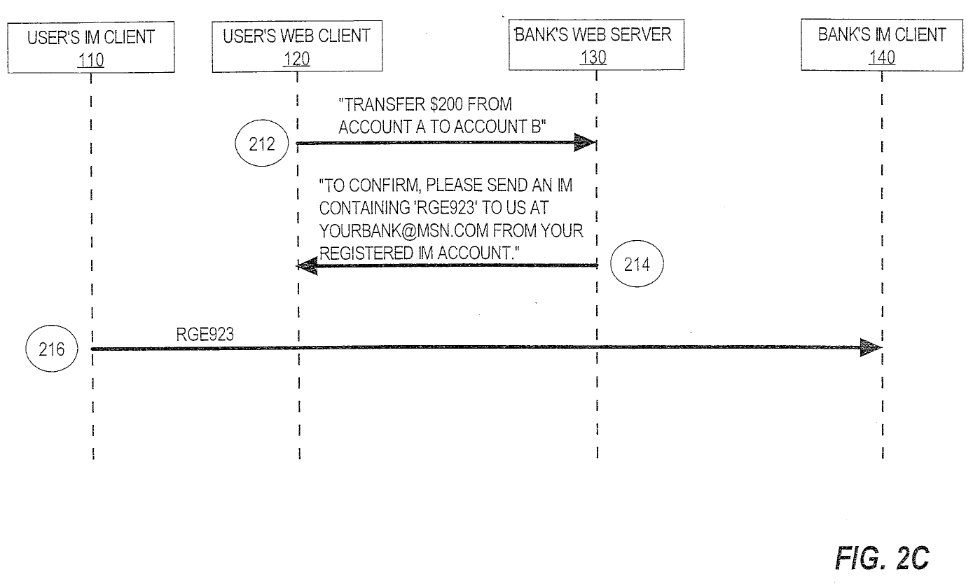

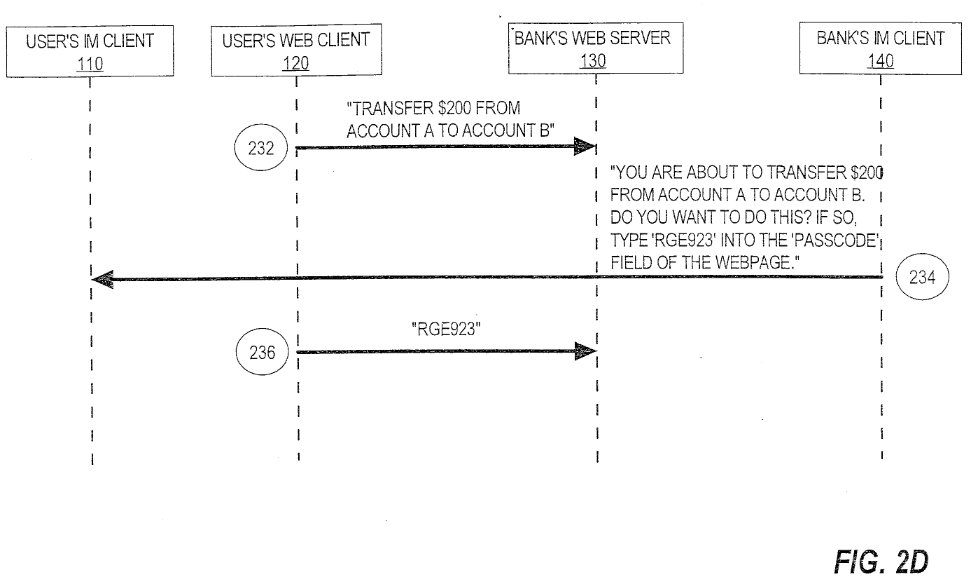

FIG. 1 is a sequence diagram that depicts an example set of communications for a user to log in to the user's online bank account, according to an embodiment of the invention. In FIG. 1 (as well as in FIGS. 2A-D), the application provider is a bank. Also, the user's client device executes both an IM client 110 and a web client 120. A message between the user's web client 120 and the bank's web server 130 is considered to be an in-band (IB) message (because the message is sent using HTTP), whereas an IM message between the user's IM client 110 and the bank's IM client 140 is an out-of-band (OOB) message.

Although not depicted in FIGS. 1 and 2A-D, OOB messages and IB messages are sent over a network. The network may be implemented by any medium or mechanism that provides for the exchange of data between entities 110-140. Non-limiting examples of the network include one or more Local Area Networks (LANs), one or more Wide Area Networks (WANs), the Internet, or any combination thereof.

At step 102 of FIG. 1, web client 120 sends a login request to web server 130. The login request includes a username of the user of web client 120. At step 104, web server 130 instructs IM client 140 to IM the user. At step 106, IM client 140 IM's the user, i.e., by sending, to IM client 110, an IM message that states: “Hi John, Please enter ‘12345’ in to your browser.” This password is referred to as a one-time password (OTP).

At step 108, web server 130 sends, message to web client 120, a message that states: “Please enter token from IM just sent to you.”

At step 110, the user of web client 120 enters the token into the corresponding web browser. Web client 120 sends the token to web server 130.

At step 112, web server 130 sends, to web client 120, a message that requests a password if the submitted token is valid. At step 114, the user enters and submits the password to web server 130. At step 116, web server 130 sends, to web client 120, a message that indicates that the user is logged in.

Alternatively, the steps of FIG. 1 may be in a different order. For example, the user of web client 120 first enters his/her username and password. Subsequently, the user is prompted for the OOB OTP.

### Post-Login User Authentication Examples

FIGS. 2A-D are sequence diagrams that depict example sets of communications to authenticate a user after the user has logged in to the user's personal account, according to an embodiment of the invention.

FIG. 2A includes an OOB challenge and an OOB response. At step 202, web client 120 sends a request to web server 130 to transfer $200 from Account A to Account B. At step 204, in response, the bank IM's the user the following: “You are about to transfer $200 from Account A to Account B. Do you want to do this? If so, reply with ‘RGE923’.” At step 206, the user replies by IMing the bank the character sequence ‘RGE923’. Thereafter, because the user has authenticated him/herself, the bank completes the transaction.

FIG. 2B includes an OOB challenge and an IB response. At step 212, web client 120 sends a request to web server 130 to transfer $200 from Account A to Account B. At step 214, in response, the bank IM's the user: “You are about to transfer $200 from Account A to Account B. Do you want to do this? If so, click <here>.” The ‘<here>’ is a clickable link to the application provider. At step 216, the user selects the link, which causes a request for the URL associated with the link, to be sent to web server 130. Thereafter, because the user has authenticated him/herself, the bank completes the transaction.

FIG. 2C includes an IB challenge and an OOB response. At step 222, web client 120 sends a request to web server 130 to transfer $200 from Account A to Account B. At step 224, in response, web server 130 sends the following message to web client 120, i.e., via the normal communication channel: “To confirm, please send an IM containing ‘RGE923’ to us from your registered IM account.” At step 226, the user IM's the bank the character sequence ‘RGE923’. Afterward, bank treats the user as legitimate.

FIG. 2D is a variation of FIG. 2B and also includes an OOB challenge and an IB response. At step 232, web client 120 sends a request to web server 130 to transfer $200 from Account A to Account B. At step 234, in response, the bank IM's the user: “You are about to transfer $200 from Account A to Account B. Do you want to do this? If so, type ‘RGE923’ into the ‘Passcode’ field of the web page.” At step 234, the user enters ‘RGE923’ into the ‘Passcode’ field of the webpage via web client 120 and submits the passcode. Thereafter, because the user has authenticated him/herself, the bank completes the transaction.

Many variations may be made to the above challenge-response sequences. For example, the OOB challenge and IB response sequences depicted in FIGS. 2B and 2D may be combined to result in the following OOB challenge: “You are about to transfer $200 from Account A to Account B. Do you want to do this? If so, click <here>or type ‘RGE923’ into the ‘Passcode’ field of the web page.” Additionally, any of the above examples may be extended with multiple steps to authenticate the application to the user and then the user to the application, or vice versa.

In an embodiment, instead of a random (or pseudo-random) sequence of characters (such as ‘RGE923’) as responses, pre-established knowledge-based responses may be used. For example, the challenge (whether OOB or IB) may be “If this is what you intended, then IM the balance from your last statement to us to confirm.” Knowledge-based challenge-response systems may include grid response (e.g., “Please enter the characters from cells A3, E1, and B5 on your BigBank grid card into the web form”), token response (e.g., “Please enter the numbers shown on the screen of your BigBank key fob into the web form now”), question-answer, password, and personal verification number.

In an embodiment, each time a transaction for a user is completed, the application provider IM's the user a message, such as the following: “You just completed a transfer of $200 from Account A to Account B. If you did not intend to do this, then click <here>.” In this way, if an illegitimate user completes an unauthorized transaction, then the legitimate user will be notified immediately.

In an embodiment, prior to IM usage, both the application provider and the user share IM identities. For example, during enrollment with the service, the application provider allows the user to specify the user's IM account, either explicitly or implicitly through an email address, such as user42@gmail.com. The user may add the application provider's IM identity to the user's ‘buddy list’ in the user's IM application. Alternatively, the user may accept an IM invitation from the application provider (e.g., from anybank@gmail.com). This alternative has a disadvantage of possibly recreating phishing scenarios in the IM context.

The application provider may direct communication to only one IM account/service or to many IM accounts. For example, a user may have numerous IM accounts, in which case, a bank may ask for the IM identity associated with each IM account.

The application provider may also implement features to provide different behaviors when the user is logged in, is in ‘busy’ mode, or logged out. For example, the application provider detects that the user is not logged into their IM account. As a result, the application provider reverts to authentication without leveraging IM or directs the user to login to their IM account before proceeding. In a related example, the application provider sends an IM to each of the user's registered IM accounts that are currently not “busy” or logged out.

Although the foregoing examples are in the context of authenticating a user to a bank (and/or vice versa), embodiments of the invention are not so limited. Any two entities may be authenticated to one another in a similar manner.

### Types of Data in IM Messages

In addition to the text IM messages that are sent to a user, IM messages to the user may include other types of data. For example, an IM message may include audio, video, an image, emoticons, environments, avatars, or any combination of the above.

Similarly, IM messages that are sent to an application provider (such as the bank in the above examples), such IM messages may include other types of data, rather than (only) simple text. For example, such IM messages may include audio (e.g., in response to an instruction to read back “Mary had a little lamb”), video (e.g., in response to an instruction to “Record the screen as we flash a pattern on it”), an image (e.g., in response to an instruction to “Choose one of these images that is your dog”), and/or a photo (e.g., in response to an instruction to “Take a picture of your eye for a retinal scan”).

### Additional Authentication use Cases

The following are additional, non-limiting examples of how an IM channel may be used to authenticate the user and/or the application provider.

User Authentication Example 1. An application provider and a user IM each other in a challenge-response sequence for a given transaction. For example, a bank, via the normal communication channel (e.g., via a web browser), informs a user that the user will soon be receiving an IM from the bank, which IM will prompt the user for identification. The IM message to the user from the bank states: “Hello John. You are about to transfer $10,000 from Account A to account B. If you would like to complete this transaction, please enter the transaction identification number from the web screen in the chat box.” John IM's the transaction identification number to the bank. In response, the bank IM's John the following statement: “Thank you. This is a valid transaction. In order to complete the transaction, please enter the following one time password into the web screen in front of you: 788TTR34.”

User Authentication Example 2. This example is similar in respects to User Authentication Example 1 above, except using a private verification number (PVN) option. For example, a bank, via the normal communication channel (e.g., via a web browser), informs the user that the user will soon be receiving an IM from the bank, which IM will prompt the user for identification, which should be the user's PVN. The IM message to the user from the bank states: “Hello John. You are about to transfer $10,000 from Account A to Account B. If you would like to complete this transaction, please enter your PVN.” John IM's the bank his PVN. In response, the bank IM's John the following statement: “Thank you. You have been successfully identified. In order to complete the transaction, please enter the following one time password into the web screen in front of you: 788TTR34.”

Server Authentication Example. Upon logging in to a server, the server IM's the user the user's personalized content (e.g., text/image/sound/video) that the user has pre-configured to see upon login. For example, upon logging in to a bank's website, a user receives an IM with the following statement: “Welcome back to AnyBank, John. <John's preselected image>”. Such an IM message upon logging in has the benefit of setting an expectation to John that he should receive an IM when using the bank's website, and that if an imposter manages to log in to John's account, John will be notified immediately. Further, if John does not receive an IM message on login, then he will be skeptical of whether he is logged into the correct site.

In an embodiment, at least some IM messages from an application provider to a user include personalized content in order to authenticate the application provider, i.e., that the message is really coming from the application provider and not from an imposter.

The above methods may be combined so that upon logging in, an IM message from the application provider to the user includes a server authentication piece and requests client authentication in a single message. For example, a bank IM's a user the following message: “Welcome back to AnyBank, John. <John's preselected image> To verify your login to AnyBank, please enter “4j3id736” into the text box in your browser or <click here>.”

### Benefits

Multiple benefits may be realized from embodiments of the invention. One benefit is an increase in the confidence level of both the user and the application provider that they are communicating with and transacting with the desired second party, without significantly increasing costs of the overall solution.

Another benefit is that an authentication communication channel is added that bypasses possibly compromised web browsers and HTTP traffic, without requiring a separate communications device.

Another benefit is that layers of additional authentication factors are added through the user's and application provider's IM service identities without requiring a separate communications device or a separate authenticator.

Another benefit is the ability to perform dynamic, real-time challenge/response exchanges at any point in the transaction flow, through a distinct communication channel, but without requiring a separate communications device.

Yet another benefit is the ability to leverage broadly deployed software (i.e., IM applications). This means that IM applications are very likely to be available on the same device being used to access, e.g., a web banking application, even if that device is not the user's default device, which is the case when the user is at an internet cafe. Thus, IM's ubiquity reduces barriers to adoption and use by not requiring any software download or installation.

Yet another benefit is higher success rates through reduced transcription errors while entering responses to questions and challenges by supporting cut and paste usage between the IM client window and, e.g., a web browser application.

### Hardware Overview

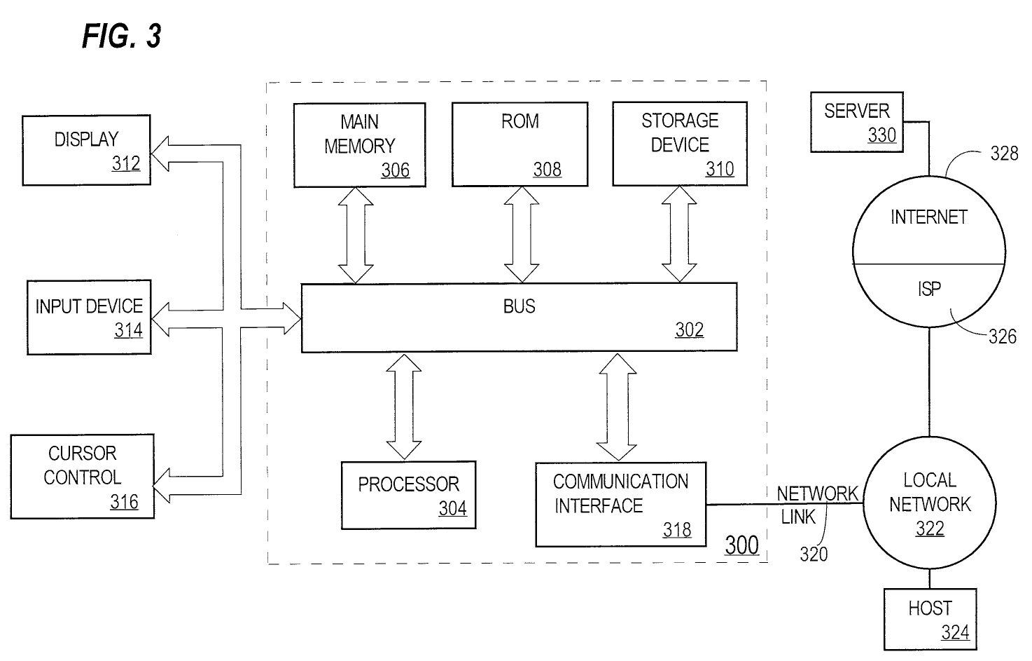

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to storage media and transmission media. Storage media includes both non-volatile media and volatile media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or modem (e.g., a digital subscriber line (DSL) or cable modem) to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A machine-implemented method comprising:
receiving, from a client device, via a first communication channel, a request for a service provided by a server;
after receiving the request, establishing an instant messaging (IM) communication channel with the client device, wherein both the server and the client device execute an IM client; wherein the IM communication channel is different than the first communication channel;
using the IM communication channel to authenticate a user of the client device; and
completing the request through the first communication channel.

2. The method of claim 1, wherein authentication data that is sent via the IM communication channel is one of text, audio, an image, video data, or any combination thereof.

3. The method of claim 1, wherein using the IM communication channel includes:
sending, to the client device, via the IM communication channel, an IM message that instructs the user to send particular authentication data via the first communication channel;
receiving, from the client device, via the first communication channel, first authentication data;
in response to determining that the first authentication data is the same as the particular authentication data, providing, to the client device, confidential information related to the user.

4. The method of claim 1, wherein using the IM communication channel includes:
sending, to the client device, via the first communication channel, a message that instructs the user to send particular authentication data via the IM communication channel;
receiving, from the client device, via the IM communication channel, an IM message that includes first authentication data;
in response to determining that the first authentication data is the same as the particular authentication data, providing, to the client device, confidential information related to the user.

5. The method of claim 1, wherein using the IM communication channel includes:
sending, to the client device, via the IM communication channel, a first IM message that instructs the user to send particular authentication data via the IM communication channel;
receiving, from the client device, via the IM communication channel, a second IM message that includes first authentication data;
in response to determining that the first authentication data is the same as the particular authentication data, providing, to the client device, confidential information related to the user.

6. The method of claim 1, wherein:
for each IM message of one or more IM messages that is sent to the client device via the IM communication channel, said each IM message includes authentication data that authenticates the server to the user.

7. The method of claim 6, wherein one of the one or more IM messages is sent in response to receiving login information from the client device.

8. The method of claim 1, wherein:
the first communication channel uses a first port on the client device and the IM communication channel uses a second port on the client device; and
the first port is different than the second port.

9. The method of claim 1, wherein completing the request through the first communication channel includes using Hypertext Transfer Protocol (HTTP) to send and receive data via the first communication channel.

10. The method of claim 1, wherein authentication data sent via the IM communication channel is encrypted.

11. The method of claim 1, further comprising the step of, prior to establishing the IM communication channel, sending, to the client device, a digitally-signed IM client to enable use of the IM communication channel.

12. A machine-readable storage medium storing instructions which, when executed by one or more processors, cause the one or more processors to perform the method of claim 1.

13. A machine-readable storage medium storing instructions which, when executed by one or more processors, cause the one or more processors to perform the method of claim 2.

14. A machine-readable storage medium storing instructions which, when executed by one or more processors, cause the one or more processors to perform the method of claim 3.

15. A machine-readable storage medium storing instructions which, when executed by one or more processors, cause the one or more processors to perform the method of claim 4.

16. A machine-readable storage medium storing instructions which, when executed by one or more processors, cause the one or more processors to perform the method of claim 5.

17. A machine-readable storage medium storing instructions which, when executed by one or more processors, cause the one or more processors to perform the method of claim 6.

18. A machine-readable storage medium storing instructions which, when executed by one or more processors, cause the one or more processors to perform the method of claim 7.

19. A machine-readable storage medium storing instructions which, when executed by one or more processors, cause the one or more processors to perform the method of claim 8.

20. A machine-readable storage medium storing instructions which, when executed by one or more processors, cause the one or more processors to perform the method of claim 9.

21. A machine-readable storage medium storing instructions which, when executed by one or more processors, cause the one or more processors to perform the method of claim 10.

22. A machine-readable storage medium storing instructions which, when executed by one or more processors, cause the one or more processors to perform the method of claim 11.
